(19) United States
(12) Patent Application Publication
(10) Pub. No.: US 2025/0209482 A1
(43) Pub. Date: Jun. 26, 2025

(54) USER EXPERIENCE/INTERACTIONS FOR MOVIES IN THEATER

(71) Applicant: Angel Studios, Inc., Provo, UT (US)

(72) Inventor: Ajay Madhok, Provo, UT (US)

(21) Appl. No.: 18/985,198

(22) Filed: Dec. 18, 2024

Related U.S. Application Data
(60) Provisional application No. 63/613,605, filed on Dec. 21, 2023.

(51) Int. Cl. G06Q 30/0204; G06Q 30/0251; H04N 21/258; H04N 21/2668; H04N 21/81

(52) U.S. Cl. CPC G06Q 30/0204; G06Q 30/0269; H04N 21/25883; H04N 21/2668; H04N 21/812

(57) ABSTRACT

A system for an improved user experience for viewing a movie in a movie theater may comprise an experience optimization server configured to (1) obtain information about audience characteristics for a movie showing and (2) customize the movie showing based on the audience information. Audience information may comprise demographics, preferences, movie consumption history, demand shaping, and/or demand identification. Customization may comprise customizing trailers, marketing, concessions, merchandise, and/or movie content.

### BACKGROUND OF THE INVENTION

The movie theater is an iconic American experience that has unfortunately not changed significantly in decades. Despite significant improvements in technology over recent years and decades, movie theaters seem to be stuck in the rut of moviegoer experience and interactions that have defined the theater experience for decades. Additionally, the conventional movie theater paradigm is inefficient in its use of valuable resources including trailers, advertising, concessions, and movie content.

What is needed is technological improvements to the movie theater experience to improve moviegoer experience and interactivity, and additionally to more efficiently exploit trailers, advertising, concessions, and movie content.

### BRIEF SUMMARY OF THE INVENTION

A system for an improved user experience for viewing a movie in a movie theater may comprise an experience optimization server configured to (1) obtain information about audience characteristics for a movie showing and (2) customize the movie showing based on the audience information. Audience information may comprise demographics, preferences, movie consumption history, demand shaping, and/or demand identification. Customization may comprise customizing trailers, marketing, concessions, merchandise, and/or movie content.

### BRIEF DESCRIPTION OF THE DRAWINGS

FIG. 1 shows a flowchart for an exemplary method as described herein.

FIG. 2 shows a flowchart for an exemplary method as described herein.

### DETAILED DESCRIPTION OF THE INVENTION

A system and method are disclosed for improving movie theatre interactions with customers/patrons. Although the disclosure herein focuses on movie theatres, movie tickets, and the experience related to acquiring tickets for and attending a movie—the inventions and innovations herein apply analogously to other events, e.g., events for which an attendee user must acquire tickets and attend. This may include, but is not limited to, sporting events, music concerts, and other in-person performances/events.

### I. Demand Shaping to Optimize Trailers, Advertising, Concessions, and Content

An Experience Optimization Server may obtain information about audience characteristics/demographics for a presentation of media or a performance. Based on such information, the Experience Optimization Server may customize resources, e.g., advertising associated with the presentation of media or the performance. Information about audience characteristics/demographics may include media content preferences and media consumption history.

Media may include movies, shows, YouTube content, social media, music services, media available on the Internet, media available remotely other than through the Internet, and/or media at in-person venues such as movie theaters, arenas, or other performance venues.

Media content preferences may include any information about media that a user likes (or has other feelings about), frequently consumes, and/or desires to consume. Media consumption history may include information about a user's viewing, listening, attendance, and/or other consumption of media. Such consumption history information may include, but is not necessarily limited to, identification of the media (e.g., name, title, identification number, URL, etc.), date/time of consumption, user's physical location at time of consumption, circumstances of consumption (e.g., along, with friends, with others, outside/inside, free/paid/gifted, when ticket was purchased/acquired, when ticket was purchased/acquired relative to consumption, consumed all at once or in parts, some or all consumed multiple times), consumption device (e.g., smartphone, laptop, tablet, desktop, home theater, movie theater screen/sound, etc.), and/or any other information that would provide information about a user's consumption of media or of performances.

In one embodiment, the media may be movies. The user's media content preferences may include movie genre, rating, reviews, actors, and/or features (e.g., vulgarity, nudity, sex, etc.). The user's media consumption history may be information about movies the user has seen, attended, and/or purchased tickets for. Specific information may include, e.g., name/identification of movie, date/time tickets purchased, method for purchasing tickets, location/date/time user watched movie. For the sake of clarity, when “view” and “watch” are used herein with reference to a “movie,” e.g, “viewing” or “watching” a movie, “view” and “watch” should be understood colloquially to mean consuming a movie by both watching and listening to the movie—and not in a hyper-literal sense such as watching the movie but not hearing the sound component of the movie.

Additionally, it should be understood that ideas disclosed herein for a single user may apply analogously to a group, set, or class of users.

### I.A. General Consumer Information

The Experience Optimization Server may obtain information about a user's characteristics, demographics, consumer history, consumer preferences, and/or any other information relevant to consumer inclinations. Additionally, as described herein below, the Experience Optimization Server may obtain information about classes or categories of consumers with which a consumer may be associated.

I.B. Information about Movie Preferences

The Experience Optimization Server may obtain information about a user's movie preferences. This information may come from one or a combination of multiple sources, including but not limited to: information the user input into an app, website, messaging service, social media platform, or other electronic data collection system regarding direct or indirect information about a user's movie preferences (e.g., an app could be used to solicit from the user, “Please help us to understand your movie preferences by entering the following information”); the user's movie consumption history; reviews the user has made/left for one or more movies; demographic information about the user; the user's affiliation with groups or associations (e.g., Facebook group named “Horror Movie Lovers”); information reported by the user's friends, relations, or associates; online behavior, e.g., websites visited, social media apps used, accounts followed, social media pages subscribed to or visited, Internet cookies; groups with which the user is associated; the user's purchasing history/decisions, and/or other sources that may reflect a user's movie preferences.

### I.C. Demand Shaping

The Experience Optimization Server may obtain information about the movie preferences or inclinations for a class of users. Some of this information may come from the same sources identified above for a single user. Additional information about the movie preferences of a class of users may be derived or obtained through the use of demand shaping. As used in this context, demand shaping may refer to information that is inferred about a class of users/consumers attending (or who purchased tickets for) a movie showing (as used herein, “movie showing” refers to a showing of a specific movie at a specific location, date, and time) based on known advertising, marketing, or analogous activities associated with the particular location and time for the movie showing. For example, in one exemplary embodiment, a movie studio/distributor/promoter (“distributor” will be used herein below for convenience) may have at a specific theater location one screen on one day for a movie called The Shift. This single screen on a single day may have six showtimes: 11:00 am, 1:00 pm, 3:00 pm, 5:00 pm, 7:00 pm, and 9:00 pm.

The distributor may use demand shaping in its marketing. For example, the distributor may run Facebook ads in the Facebook group named “Classic American Motor Cars” for the showings at 11:00 am, 3:00 pm, and 7:00 pm. This may be done by including only those three showtimes in the advertisements, e.g., “Buy your tickets now for this Friday at Silver Mountain Theater: 11:00 am, 3:00 pm, and 7:00 pm.” The distributor may run ads in the Facebook group named “Extreme Cycling for Elderly Grandmas” for the showings at 1:00 pm, 5:00 pm, and 9:00 pm. This may be done by including only those three showtimes in the advertisements, e.g., “Buy your tickets now for this Friday at Silver Mountain Theater: 1:00 pm, 5:00 pm, and 9:00 pm.”

Many other variants and strategies for demand shaping may be used to target different audiences or to “shape” audiences for different movies, locations, dates, and showtimes. Demand shaping may include, but is not limited to, advertising over different media; advertising in different physical locations; advertising in different virtual locations (e.g., websites, social media platforms, social media pages/accounts, email lists, texting lists, keyword advertising, etc.); and/or any way, technique, or strategy known in the art for targeting classes of users/customers.

Another variant of demand shaping may be referred to as demand identification. For example, continuing with the example for the movie The Shift and the Facebook groups for “Classic American Motor Cars” and “Extreme Cycling or Elderly Grandmas,” the movie distributor may offer all locations/dates/times for showings of The Shift in similar marketing campaigns on both the “Classic American Motor Cars” Facebook group and the “Extreme Cycling for Elderly Grandmas” Facebook group. By using different purchase links or other known Internet marketing techniques, the Experience Optimization Server may track by each specific showing the number of tickets originating from marketing on the “Classic American Motor Cars” Facebook group and the number of tickets originating from marketing on the “Extreme Cycling for Elderly Grandmas” Facebook group. Trailers, advertising, concessions, merchandise, and/or movie-content may be customized and/or adjusted based on these ticket counts for a particular showing. These changes may be based on, e.g., the number of tickets originating from one of the Facebook groups exceeding some threshold, the number of tickets originating from one of the Facebook groups accounting for some minimum proportion of total tickets sold or total tickets available for a specific showing, the proportion of the number of tickets originating from the “Classic American Motor Cars” Facebook group compared to the number of tickets originating from the “Extreme Cycling for Elderly Grandmas” Facebook group; or any other count or computation based on the number of sold tickets (or proxy or heuristic for sold tickets) originating from marketing for one or either of the two Facebook groups.

In one embodiment, bundling or ticket order size may be used for demand shaping and/or demand identification. For example, a significant discount may be offered for purchasing five or more tickets together. Based on this assumption that offering a significant discount will encourage families to purchase tickets or that it is more likely that families will purchase tickets for the showing, the Experience Optimization Server may surmise/anticipate that a significant proportion of the attendees at the movie showing will be families with children. Similarly, based on ticket sales data showing that most ticket orders/purchases for a specific movie showing were for at least four tickets together, it may be surmised/assumed that a significant proportion of attendees at the movie showing will be families with children.

### I.D. Movie Consumption History

The Experience Optimization Server may obtain information about the user's movie consumption history from one or a combination of multiple sources, including but not limited to: information from online accounts, e.g., Netflix and Amazon, about movies a user has viewed, streamed, or purchased; ticket purchase history, which may be available for a user who has purchased tickets through one or more websites, apps, or other ticket-purchasing intermediaries; or any other source for information about the user's movie consumption history or ticket purchase history.

### I.E. Customization of Theater Experience

Based on the obtained information about one or more attendees at a specific movie showing (or ticket purchasers for the specific movie showing), the Experience Optimization Server may customize one or more aspects of the theater experience for the specific location/date/time showing of the movie.

These customizable aspects may include, but are not limited to, trailers; advertising presented or shown in conjunction with the movie (e.g., advertisements for products, services, or concessions shown on the movie screen); movie posters on the walls or otherwise displayed in the theater, which may be paper/print, electronic displays, audio, etc.; other advertising or marketing materials shown or presented in the theater; the concessions offered in the theater; merchandise offered in the theater; and/or the content of the movie.

### I.E.1. Trailers

The trailers shown in conjunction with a movie may be modified and/or customized based on information about the characteristics or demographics of the audience. This may include any of the user/class/audience information described herein above. Changing/customizing the trailers may comprise changing the movie(s) for which trailers are shown, changing to a different trailer(s) for the same movie(s), changing to modified versions of the same trailer(s) for the same movie(s), and/or changing the order in which the trailers are shown.

For example, continuing with the example about The Shift and demand shaping using the “Classic American Motor Cars” and the “Extreme Cycling for Elderly Grandmas” Facebook groups, the Experience Optimization Server may determine to show, at movie showings for The Shift, a trailer for the movie The Fast and the Furious at the 11:00 am, 3:00 pm, and 7:00 pm showtimes-which are the showtimes emphasized/offered through Facebook marketing to the “Classic American Motor Cars” Facebook group. The Experience Optimization Server may determine to show a trailer for the movie Old Dudes on Bicycles at the 1:00 pm, 5:00 pm, and 9:00 pm showtimes-which are the showtimes emphasized/offered through Facebook marketing to the “Extreme Cycling for Elderly Grandmas” Facebook group.

Although the Experience Optimization Server cannot verify or guarantee that the audience for the 11:00 am, 3:00 pm, and 7:00 pm showtimes (“Classic American Motor Cars” Facebook group) will be more responsive from a marketing perspective to The Fast and the Furious trailer than to the Old Dudes on Bicycles trailer, the Experience Optimization Server can reasonably and with a high degree of confidence infer/speculate/surmise that this will be the case and that the trailer is better used for The Fast and the Furious than for Old Dudes on Bicycles. Similarly, although the Experience Optimization Server cannot verify or guarantee that the audience for the 1:00 pm, 5:00 pm, and 9:00 pm showtimes (“Extreme Cycling for Elderly Grandmas” Facebook group) will be more responsive from a marketing perspective to the Old Dudes on Bicycles trailer than to The Fast and the Furious trailer, the Experience Optimization Server can reasonably and with a high degree of confidence infer/speculate/surmise that this will be the case and that the trailer is better used for Old Dudes on Bicycles than for The Fast and the Furious.

Similar and/or analogous decisions about trailers shown in conjunction with a movie may be made based on other information about audience characteristics/demographics/preferences including but not limited to demand shaping, movie preferences, and/or movie consumption history.

### I.E.2. Advertising

Advertising, movie posters, and other in-theater marketing, concessions, merchandise, and/or content of the movie may also be modified, adjusted, and/or tuned based on known or surmised information about the audience at a particular movie showing. The ads shown in conjunction with a movie may be modified and/or customized based on information about the characteristics of the audience. In a typical or conventional theater experience, several ads may be shown on the movie screen prior to beginning the movie. Additionally, a movie theater often has many advertisements shown/presented in ways other than on the movie screen, e.g., print or electronic movie posters on the walls or in other locations; print or electronic advertisements for products or services shown or presented in the numerous places in the theater, e.g., concession areas, entry areas, restrooms, cinema entrances; audio; etc. As described above regarding trailers, ads and marketing materials may be modified based on known or surmised information about the characteristics/demographics/preferences of an audience for a specific showing of a movie.

### I.E.3. Concessions and Merchandise

Concessions, in-theater merchandise, and content of the movie may be analogously modified based on known or surmised information about the characteristics/demographics/preferences of an audience for a specific showing of a movie. With concessions, for example, barbecue food may be offered (and/or emphasized in marketing and/or signage) for the showings for which demand shaping or other information suggests that people affiliated with the “Classic American Motor Cars” Facebook group will be attending, and fruit smoothies may be offered (and/or emphasized in marketing and/or signage) for the showings for which demand shaping suggests that people affiliated with the “Extreme Cycling for Elderly Grandmas” Facebook group will be attending. With merchandise, for example, different merchandise, marketing, signage, and/or promotions may be offered and/or presented based on information about the audience.

### I.E.4. Movie Content

With movie content, for example, in one version of the movie—that may be shown to the “Classic American Motor Cars” audience—a scene may show actors/characters drinking Jack Daniels whiskey. In an alternative version of the movie—that may be shown to the “Extreme Cycling for Elderly Grandmas” audience, the same scene may show the same actors/characters drinking Diet Coke.

### I.F. Process for Using Demand Shaping to Customize Trailer Spot for Specific Movie Showing

An exemplary process for using demand shaping to customize a trailer spot for a movie showing may comprise some or all of the following steps, not necessarily performed in the order disclosed herein:

The first step may comprise identifying a movie showing: feature movie (the movie with which the trailer spot will be shown), a theater location, a screen, and a showing time.

The next step may comprise employing targeted marketing, as described herein above, for the movie showing to target a class of potential moviegoers having desirable or known characteristic(s).

The next step may comprise adjusting, for the specific movie showing, the content of the trailer spot based on the characteristics of the targeted marketing class. Alternatively, the trailer spot may be sold, marketed, and/or auctioned to another party based on the known/believed/presumed characteristics/demographics/preferences of the audience for the movie showing.

### I.G. Additional/Alternative Process for Using Demand Shaping to Customize Trailer Spot for Specific Movie Showing

An exemplary process for using demand shaping to customize a trailer spot for a movie showing may comprise some or all of the following steps, not necessarily performed in the order disclosed:

The first step may comprise identifying a movie showing: feature movie (the movie with which the trailer spot will be shown), a theater location, a screen, and a showing time.

The next step may comprise marketing to two or more classes of potential moviegoers, the two classes having different characteristics for marketing purposes. The marketing and/or sales means for each class may be separable, meaning it is possible to distinguish ticket sales for a first class from ticket sales for a second (or another) class.

The next step may comprise adjusting, for the specific movie showing, the content of the trailer spot based on the number of tickets sold (or some other metric of interest/sales/attendance) for each class. For example, in an example comprising two classes, the trailer may be tailored to the class having the most ticket sales for the movie showing. Alternatively, the trailer spot may be sold, marketed, and/or auctioned to another party based on the number of tickets sold for each class.

### I.H. Additional/Alternative Process for Using Demand Shaping to Customize Trailer Spot for Specific Movie Showing

An exemplary process for using demand shaping to customize a trailer spot for a movie showing may comprise some or all of the following steps, not necessarily performed in the order disclosed:

The first step may comprise identifying a movie showing: feature movie (the movie with which the trailer spot will be shown), a theater location, a screen, and a showing time.

The next step may comprise marketing to two or more classes of potential moviegoers, the two classes having different characteristics for marketing purposes. The marketing and/or sales means for each class may be separable, meaning that it is possible to distinguish ticket sales for a first class from ticket sales for a second (or another) class.

In the next step, based on early or initial ticket sales, or on other heuristics or proxy indicators of interest/attendance at the movie showing (e.g., clicks on a “Buy Tickets Now” button), marketing for one or more of the classes may be progressively decreased or turned off, so that marketing may eventually focusing on just one class or a set of classes that omits one or more of the classes from the original set of marketing classes.

The following is an example of how this process may be implemented: For a movie showing, initial advertising may target three classes: single men ages 18-29; married men ages 18-55; and single men ages 30-55. Marketing to all three classes may begin at the same time or at approximately the same time. Regardless of whether marketing begins the same time, it is important that marketing be carried out in a way that facilitates comparison of the response per marketing dollar or response per marketing resource for the three classes.

Based on initial/early/preliminary responsiveness of the three classes relative to each other, select only one class (or less than the number of initial classes) for focusing marketing efforts. For example, if in the first hour of marketing 20 tickets sold for the first class (single men ages 18-29), 3 tickets sold for the second class (married men ages 18-55), and 3 tickets sold for the third class (single men ages 30-55), then marketing for the second and third classes may be immediately turned off to focus marketing efforts on the first class.

One benefit of this process may be to make a trailer spot more valuable by increasing the homogeneity (or presumed/predicted homogeneity) of the audience for the movie showing.

The next step may comprise adjusting, for the specific movie showing, the content of the trailer spot based on the characteristics of the targeted class(es). Alternatively, the trailer spot may be sold, marketed, and/or auctioned to another party based on the characteristics of the targeted class(es).

### I.I. Process for Promoting Movie, Good, or Service Through Tailored Trailer Spot or Other Marketing Resource

An exemplary process for promoting a movie, good, or service through a tailored trailer spot or other marketing resource may comprise some or all of the following steps, not necessarily performed in the order disclosed:

The first step may comprise accessing an app or website that presents an interface for searching and/or purchasing trailer spots. The app/website may facilitate searching for trailer spots by audience characteristics, demographics, and/or preferences.

Search results may show, display, or otherwise present movie showings or sets of movie showings, comprising some or all of the following information: name of feature movie; location of showing; screen number/identifier for showing; date of showing; time of showing; audience characteristics/demographic; additional details about the trailer spot such as length, content restrictions, and rating restrictions; and a price or price range for the trailer spot.

The search system (or the system providing information to the search system) may obtain information about audience characteristics/demographics/preferences from one or a combination of several sources. In one embodiment, as described herein above, audience characteristics/demographics/preferences may be surmised/predicted based on demand shaping, e.g., a movie showing had been advertised exclusively to Facebook groups having (or believed to have) a high concentration of single males in the age range 18-29. In another embodiment, a trusted third-party may be able to provide information or assurances about the audience characteristics/demographics, e.g., “75% of the audience will be single males in the age range 18-29.” The third party's information may originate or be based on one or more of the information sources described herein.

In another embodiment, audience characteristics/demographics/preferences may be surmised/predicted based on known (or believed) attributes of a set known ticket purchasers. For example, 20% of ticket sales for a movie showing may come through an entity/service where users login or have an account, such as Fandango, and the service may have access to information about the user through the user's history/purchase history or other information that has been collected about the user. This characteristics/demographics information about 20% of the audience may be extrapolated to predict characteristics/demographics information for some or all of the remaining 80% of the audience.

The interface may present controls for selecting a trailer spot or set of trailer spots and paying for or confirming the trailer spot or set of trailer spots.

An analogous process may be used for theater marketing, advertising, and/or promotional resources other than trailer spots, e.g., on-screen advertisements, movie posters on walls, etc.

The systems and processes disclosed and described herein address and/or solve significant technology problem: inefficient use of trailer spots, marketing content, and movie content in a movie theater setting. Although in the age of the Internet much is known and could be known about the characteristics/demographics/preferences of an audience for a movie showing, or at least about one or more members of the audience for a movie showing, and additionally many techniques are available for demand shaping and thereby controlling to some extent the characteristics/demographics/preferences of the audience for a movie showing, these opportunities have not been exploited to optimize the trailers, marketing content, and movie content in a movie theater setting.

I.J. Process for Improving Exploitation of Trailer Spots, Marketing Resources, and Movie Content Associated with a Movie Showing

An exemplary process for improving exploitation of trailer spots, marketing resources, and movie content associated with a movie showing may comprise some or all of the following steps, not necessarily performed in the order disclosed:

The first step may comprise identifying a specific movie showing.

The next step may comprise optionally determining the value of a trailer spot absent demand shaping or additional information about the audience for the movie showing. This amount may be based on going market rates and/or other known contributing factors.

The next step may comprise accessing an app or website that presents an interface for selecting two or more classes of moviegoers that are likely to have interest in seeing the feature movie for the movie showing. These classes may be selected based on history with similar movies, personal/individual knowledge, survey data or reviews about the movie, or any other information that might suggest that the feature movie might appeal to a particular class of moviegoers.

One or more of these classes may be selected.

An interface may be presented showing (or otherwise communicating) predicted (or known) values (for sales to third parties of the trailer spot) of the trailer spot based on varying homogeneity signatures. As used herein, “homogeneity signature” may refer to the homogeneity of the audience for the movie showing over characteristics, demographics, preferences, and other attributes of the audience. For example, for an exemplary homogeneity signature the interface may indicate that the value of the trailer spot is $107 if 80% of the audience is single males in the age range 18-29 and at most half of the remaining 20% of the audience is females. Or, for an alternative homogeneity signature the interface may indicate that the value of the trailer spot is $49 if more than 50% of the audience is children under 15 years old.

In conjunction with presenting values for varying homogeneity signatures, the interface may additionally present options for achieving (or attempting to achieve) features of one or more of the homogeneity signatures. For example, if one homogeneity signature is that the trailer is worth $89 if 85% of the audience is single males in the age range 18-29 that like pickup trucks, then the interface may offer the option of focusing marketing efforts on the Facebook group, “Young Dudes Who Love Trucks More Than Girls.”

A user may select one or more of the options for achieving (or at least attempting to achieve) a homogeneity signature or feature or sub-feature of a homogeneity signature.

The system/interface may post or report progress updates on achieving the selected homogeneity signature or feature or sub-feature of a homogeneity signature.

The system may post a listing for sale/auction of the trailer spot. The listing may include reference to a homogeneity signature or homogeneity characteristics.

Although the discussion herein uses audience homogeneity as a metric for value of a trailer spot, other metrics may be used in conjunction with homogeneity to determine the value of a trailer spot. For example, a target characteristics/demographics/preferences distribution for a movie showing may be 50% single females in the age range 18-29 and 50% males in the age range 18-29. This target distribution may be based on a hypothesis/belief that males and females on dates may react better to a trailer than an audience comprising females only or an audience comprising males only.

### I.K. Flowcharts

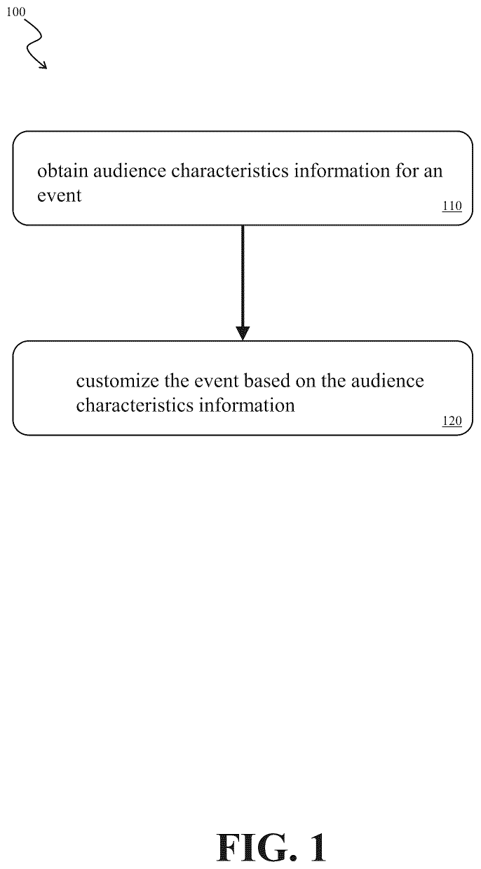

FIG. 1 is a flowchart 100 for an exemplary method for customizing an event.

At step 110 an experience optimization server may obtain audience characteristics information for an event.

At step 120 the experience optimization server may customize the event based on the audience characteristics information.

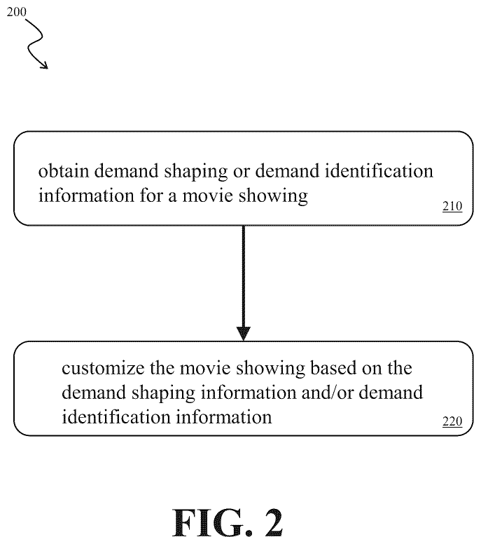

FIG. 2 is a flowchart 200 for an exemplary method for customizing an event.

At step 210 an experience optimization server may obtain demand shaping or demand identification information for a movie showing.

At step 220 the experience optimization server may customize the movie showing based on the demand shaping information and/or demand identification information.

### II. Late Binding for Movie Theater Ticket Sales

The typical/conventional paradigm for sales of movie tickets is to reserve a screen for a movie showing at a theater (specific theater, [possibly] specific screen, specific date, specific time) and to then sell tickets for that movie showing. It is possible that the specific screen at the theater may not be nailed down at the time of selling tickets, but at least the theater location, date, and time are known at the time of selling tickets.

This paradigm may result in two inefficiencies: First, a screen for a movie showing may be reserved but less than all available tickets seats may be sold for the movie showing. Second, an excessive amount of advertising may be required to sell some or all available tickets for a specific moving showing. These inefficiencies result because this paradigm—the conventional and universal paradigm for selling tickets for a movie showing—requires speculating on demand and associated advertising costs at the time the theater screen is reserved but prior to some or all advertising and prior to selling tickets for the specific movie showing.

A system and method for improved efficiency for selling movie tickets is disclosed.

This improved system and method may be referred to as “late binding.” Under the “late binding” paradigm, tickets to see a movie may be sold but those tickets may not be “bound” to a specific seat (or a set of seats in a specific cinema) under after the ticket has been purchased.

In one embodiment, an app, website, and/or electronic interface may present an interface for purchasing a movie ticket without disclosing the exact date, time, and/or location of the movie showing. For convenience in discussing and referencing the concept, a purchased movie ticket without a certain location, date, or time will be referred to as an “unbound ticket.” In some embodiments a discount may be offered for willingness to purchase an unbound ticket.

In one embodiment, an interface for purchasing an unbound ticket may comprise controls for a user to enter, select, and/or otherwise input one or more preferences for a specific movie for date(s), time(s), location(s), theater(s), seating/cinema feature(s), and/or co-audience for a movie showing. As used in this disclosure, “preference” may also refer to an anti-preference or a dislike, i.e., something a user would like to avoid. “Co-audience” may refer to a preference for a specific type of audience, e.g., people who laugh really loud, or cry audibly, or who exhibit other behaviors that may increase the desirability of watching a movie with them.

For example, a simple interface may comprise a control for selecting a location, a control for selecting a preferred date, and a control for selecting a preferred time. The control for selecting a location may allow the user to select one or more specific theater locations, or to select a geographic location (e.g., a specific location with a range, or a zip code with a range, or a city, or any other method for selecting a geographic location or geographic bounds known in the art). The control for selecting a date may allow for selecting a specific date, or a date range, or a set of not-necessarily adjacent/contiguous dates. The control for selecting a time may allow for selecting a specific time, or a time range, or a set of not-necessarily adjacent/contiguous times.

In one embodiment, the system may interpret the user's selection of a location, date, and/or time as an indication that the use has a highest preference for the selected location, date, and/or time, and that the strength of the user's preference decreases as the deviation from the selected location, date, and/or time increases. In some embodiments the system may interpret the user's selection of a location, date, and/or time as hard preferences, i.e., the actual location, date, and/or time of the ticket must satisfy the user's selected/entered preferences.

Based on the preferences input by the user—which are in a sense analogous to search criteria—the interface may present to the user offers/options for purchasing an unbound ticket. An offer for an unbound ticket may comprise some or all of movie showing attributes referenced herein—with at least one of the attributes having some uncertainty or a range of values. For example, an offer for an unbound ticket may comprise the following values:

| | |
|---|---|
| Movie Name | The Half-Red Star |
| Location | Prime Movies 17 (199 Fortenza Way, Waskippi, Illinois) |
| Date | Friday, Jan. 12, 2024 |
| Start Time | 4:00pm-8:00pm |
| Ticket Price | $11.50 |
| Latest Binding | Thursday, Jan. 11, 2024, 11:59pm CT |
| Date/Time | |

The following are several additional exemplary offers for unbound tickets:

| | |
|---|---|
| Movie Name | The Half-Red Star |
| Location | Prime Movies 17 (199 Fortenza Way, Waskippi, Illinois), |
| | or another theater within five miles of this theater |
| Date | Friday, Jan. 12, 2024 |
| Start Time | 7:00pm-8:00pm |
| Ticket Price | $11.50 |
| Latest Binding | Thursday, Jan. 11, 2024, 11:59pm CT |
| Date/Time | |

| | |
|---|---|
| Movie Name | The Half-Red Star |
| Location | Prime Movies 17 (199 Fortenza Way, Waskippi, Illinois), |
| | or another theater within five miles of this theater |
| Date | Friday, Jan. 12, 2024 OR Saturday, Jan. 13, 2024 |
| Start Time | 7:00pm-8:00pm |
| Ticket Price | $11.50 |
| Latest Binding | Thursday, Jan. 11, 2024, 11:59pm CT |
| Date/Time | |

| | |
|---|---|
| Movie Name | The Half-Red Star |
| Location | Prime Movies 17 (199 Fortenza Way, Waskippi, Illinois), |
| | or another theater within five miles of this theater |
| Date | Saturday, Jan. 13, 2024 |
| Start Time | 11:00am-8:00pm |
| Ticket Price | $13.00 |
| Latest Binding | Dec. 30, 2023, 11:59pm CT |
| Date/Time | |

The “Latest Binding Date/Time” may refer to a commitment from the ticket seller for resolving any uncertainty about the movie showing for the unbound ticket. Resolving uncertainty about a ticket so that the purchaser knows the location, date, and time for the movie showing associated with the ticket, may be referred to as “binding” the unbound ticket so that it becomes a bound ticket.

In some embodiments, uncertainty may be removed piecemeal. For example, a user may purchase an unbound ticket on Thursday, Feb. 1, 2024 for a movie showing at a specific theater location (e.g., Springfield Movies 9) that will happen on either Friday, Feb. 19, 2024 or Saturday, Feb. 20, 2024 between 4:00 pm-8:00 pm. On Saturday, Feb. 3, 2023 the user may receive a communication from the ticket seller that the movie showing will be on Saturday, Feb. 20, 2024 between 4:00 pm-8:00 pm. At this point the initially purchased ticket is partially bound: the uncertainty about the date has been resolved, but uncertainty about the time remains. On Wednesday, Feb. 7, 2023 the user may receive a communication from the ticket seller that the movie showing will be at 7:30 pm on Saturday, Feb. 20, 2024. At this point the initially purchased ticket is fully bound. The original uncertainty about the date of the movie showing and about the time of the movie showing have both been resolved.

Upon reaching one or more tickets sales thresholds or criteria, a movie distribution server may automatically request or reserve additional screens. Alternatively, the movie distribution server may provide one or more notifications to a human, an electronic device, or other entity regarding ticket sales so that the human or other entity may make decisions about acquiring additional screens for the movie.

In one exemplary embodiment, the movie distribution server may be configured to sell (or track or manage sales of) unbound tickets for the movie The Shift on Friday, Jan. 12, 2024 with a start time between 7:00 pm-9:00 pm for the locality of Springfield, Illinois. The movie distribution server may have information about local theaters, e.g., that within a ten-mile radius of a point representing the center of Springfield there are five theaters having a combined total of forty screens that are still available for the target date and time window. The movie distribution server may additionally have information about the 40 available screens, e.g., seating capacity for each screen. Based on this information, the movie distribution server may be configured to automatically reserve additional screens, or request reservation of additional screens, or provide a notification that additional screens should be reserved-based on sales criteria. For example, if the average screen seating capacity for the forty available screens is 250 seats (assuming for the sake of simplicity that none of the 40 available screens significantly deviates from this average seating capacity), then the movie distribution server may be configured to reserve a new screen each time an additional 250 unbound tickets are sold.

Many rule schemes and/or criteria may be implemented to determine when a new screen should be reserved, which screen, and for what date/time. For example, new screens may be added based on extrapolation, trends, or predictions based on sales of unbound tickets. For example, if on Dec. 16, 2023 unbound tickets for The Shift on Jan. 12, 2024 between 7:00 pm-9:00 pm are selling at a rate of 200 tickets per day, 10 screens may be immediately reserved based on the anticipation that ticket sales will likely continue at no less than 200 tickets per day and will likely accelerate as Jan. 2, 2024 approaches. Many schemes, rule sets, and/or algorithms may be employed to determine when a new screen should be reserved, which screen, and for what date/time. One implementation may use a “heat map” of dates, times, and locations based on already purchased unbound tickets and the locations, dates, and times associated with such unbound tickets.

The determination of which screen(s) (i.e., theater location, screen number/identifier at theater, date, time) to reserve next may be based on some or all of the following criteria/factors, and/or any other factors that may be relevant:
known/disclosed/speculated user preferences for location/date/time and/or theater/screen features/amenities, cost (theaters may charge different amounts depending on the theater location, the screen number, the date, and the time), reservation/purchase options (some theaters may offer different purchase options or a screen, e.g., bundling, four-walling to purchase an entire theater for a set price, per-seat-sold pricing, minimum revenue guarantee/requirement); seating capacity for the screen, screen features (e.g., sound quality, video quality, seating features, etc.), physical addresses for purchasers of unbound tickets, and/or availability of screens (screens may be reserved near to concentrations of purchasers of unbound tickets).

In one embodiment, the movie distribution server may begin binding unbound tickets as soon as sufficient seating capacity has been reserved for the sold unbound tickets. For example—continuing with the example above for the movie The Shift in Springfield on Jan. 12, 2024 with a start time between 7:00 pm-9:00pm—no screens may be reserved as of 12:00 am on Jan. 1, 2024. By 11:00 am on Jan. 1, 2024, 400 unbound tickets may have been sold for The Shift in Springfield on Jan. 12, 2024 with a start time between 7:00 pm-9:00 pm. Based in whole or in part on some or all of the factors disclosed herein above, the movie distribution server may reserve (or attempt to reserve, or provide information allowing a human to reserve or attempt to reserve) screen no. 7 (having a seating capacity of 250 seats) at River Landing Theater (2.5 miles from the center of Springfield) on Jan. 12, 2024 for a 7:30 pm showing of The Shift.

The movie distribution server may immediately begin binding some of the already purchased unbound tickets. For example, as soon as screen no. 7 at River Landing Theater is reserved for Jan. 12, 2024 for a 7:30 pm showing of The Shift, the movie distribution server may bind 250 of the 400 tickets and communicate to the associated ticket purchasers that their tickets have been bound for screen no. 7 and River Landing Theater for The Shift on Jan. 12, 2024 at 7:30 pm. The order and timing in which tickets are bound may be based on multiple factors, including but not limited: user preferences for location/screen/date/time, user priorities, the actual or anticipated value of a ticket for the reserved screen (e.g., if 7:30 pm on a Friday evening is the most valuable showing time, some or all of the 7:30 pm tickets may be reserved or set aside for users who subsequently purchase bound or unbound tickets and who have a strong preference, requirement, priority for, or are willing to pay more for the 7:30 pm tickets), and/or any other factors that may affect binding timing and/or order.

If the movie distributor is unable to acquire sufficient screens to satisfy the already purchased unbound tickets, the movie distribution server may communicate to and/or provide a notification to purchasers of unbound tickets that they have the option of selling their tickets back to the movie distributor, possibly for more than the original purchase price. The movie distribution service may provide information for an interface for such sell-backs.

In one embodiment an app or website may provide an interface that facilitates a marketplace for purchasers of tickets to trade and/or buy/sell the tickets. This may be beneficial for many reasons. For example, user 1 and user 2 may have both purchased unbound tickets for the same location and date for the 7:00 pm-9:00 pm start-time window. When the tickets are bound, user 1's tickets may be bound for a 7:00 pm showing and user 2's tickets may be bound for an 8:30 pm showing. It may be more convenient for user 1 to attend the 8:30 pm showing and for user 2 to attend the 7:00 pm showing. A marketplace interface for trading and/or buying/selling tickets may allow user 1 and user 2 to trade their tickets so that they each get a more convenient showtime.

Pricing offered by the movie distribution server may be based on several factors, including but not limited to: number of total tickets sold (a discount may be offered for early purchasers); number of screens available (when the inventory of available screens goes down, ticket prices may be increased); amount of uncertainty (a discount may be offered for users who are willing to accept higher uncertainty, e.g., a two-day window or a 30-mile-radius geographic area); desirability of uncertainty ranges (a discount may be offered for Friday or Saturday at 11:00 pm as opposed to Friday or Saturday at 7:00 pm); marketing strategies such as momentum building, etc.; cost of acquiring a screen; and/or any other relevant factors.

Pricing offered by the movie distribution server may be dynamic.

In one embodiment, instead of consummating/finalizing a sale for an unbound ticket, a potential moviegoer may be presented with an interface through which the potential moviegoer may indicate interest in location(s), date(s), and/or time(s) for a movie. This information may be used to acquire screens for one or more movie showings.

The disclosure herein may be applied to specific seat locations/features within a screening room/cinema, instead of to just getting any seat within the screening room/cinema.

### III. Interactions with Moviegoer During Credits

The content presented to a movie theater patron during the credits shown at the end (or possibly at the beginning or at other points during presentation of the content) of a feature film (or other media presentation/content) may include one or more features to facilitate and/or encourage user/viewer interaction and/or engagement.

One feature may be a preparation/anticipation message to encourage viewers to stay in the theater for an “important message,” “message,” “additional content,” “offer,” or any other type of feature or content that may be displayed or offered in conjunction with presenting the credits on the movie screen. For example, during the credits a message may appear on the screen such as, “Please wait for important message.” In conjunction with this request/encouragement to remain in the theater and wait for the message, a countdown timer may be shown on the screen so the moviegoer knows or may anticipate how long they must wait for the “important message” and/or other feature/content/offer. In one embodiment, the countdown timer may show minutes and seconds.

These messages may be presented as text only, or visual only, or audiovisual (e.g., a person speaking), or any other way a message may be presented using presentation technologies typically available in theaters (e.g., video, sound, etc.).

The message or other feature/content/offer may comprise any of the following, or a combination of one or more of the following, or any other special message/content/offer/feature: a message from an actor, director, or other person associated with the movie about the movie, the importance of the movie, a cause associated with the movie, and the importance of others seeing the movie or supporting the cause; a request to support a cause associated with the movie; a solicitation or request to purchase or help purchase movie tickets for others, which may be referred to as a request to “pay it forward”; offers to purchase movie tickets at discounts, e.g., buy-one-get-one-free; offers for tickets to other movies; offers for products or services; and/or offers or advertisement for local food, bars, or nightclubs that may be options for moviegoers to patronize after the movie (e.g., for a movie that just ended at 11:15 pm, “Check out Funners Late Night Food joint right around the corner, open until 2:00 am, show your ticket stub to get your first drink free”).

Because the content of a movie is generally static, i.e., cannot be changed without switching out the entire movie content, in many circumstances the content of the special message cannot be customized based on location, date, time, etc. One solution to this problem is to display a QR code or Internet link for moviegoers to scan/follow with their phones or other devices. The contents returned/presented from following the QR code or link may be updated based on date/time, and possibly location if the moviegoer allows location information to be submitted from their phone with the request for the content at the QR code or link location.

Several examples follow.

In one example, the “special message” may show an actor speaking about the feature movie and the importance that others see the movie. The actor may then solicit moviegoers to purchase tickets for others who may not be able to afford tickets or who may otherwise not see the feature movie in a theater. In conjunction with this solicitation, a QR code (or an Internet link/address or similar reference/address) may be shown that, when followed, presents an interface for purchasing additional “pay-it-forward” tickets for the feature movie for others.

In another example, the special message may comprise an actor thanking moviegoers for seeing the feature movie and then saying, “As a thank you, we'd like to offer some special deals to you. Follow the QR code or link to access these special deals.” When the QR code or link is followed, a web page or analogous interface is presented that allows a user to buy half-price tickets, or to buy early tickets for the actor's next movie, or other special deals or offers. Offers at the QR code web page may additionally include an opportunity to purchase merchandise-possibly at a discounted price.

In another embodiment, the QR code (or link) may direct a moviegoer to a resource/webpage/app that is location and/or time dependent. For example, the special message may say in writing, “Thank you for watching this wonderful movie. We'd like to present you with some additional offers and/or opportunities. Please follow the QR code or URL below the QR code.” The webpage at the link represented by the QR code may comprise content that is location-dependent. Although a website does not always know a visitor's location, many technologies and approaches are available and effective for a website to know, or at least guess with high confidence, a website visitor's location. Determining a website visitor's physical location is beyond the scope of this disclosure and many techniques are known in the art. These techniques include but are not limited to, IP address tracking, HTML 5 geolocation, GPS (on smartphones and other devices), cookies, Wi-Fi network physical mapping, and Bluetooth location. Users may also allow location disclosure by indicating approval when a pop-up box on a website asks to know the location of the website visitor. Users may also, of course, just type in or otherwise input their physical address in response to a request from a webpage.

The location-dependent content may include locations, hours, and offers for local eating establishment, bars, night clubs, or other businesses/services that a moviegoer might want to patronize after watching a movie (or at any time); offers to search for and purchase tickets for upcoming events in the moviegoer's locality; and/or a presentation of any other offers or information that might be location dependent (or dependent on location, date, and/or time).

In some embodiments, in which the special message is presented in conjunction with the credits for the feature movie, the credits may continue rolling while the special message is presented. For example, the credits may be shrunk and continue rolling on one side of the screen while the special message is shown on the other side of the screen.

The special message may encourage moviegoers to leave reviews for the feature movie or to engage in dialog, conversations, and/or social media platforms about the movie. For example, the QR code (or link) may direct a moviegoer to a webpage or interface for leaving a review about the feature movie. In another example, the QR code (or link) may direct a moviegoer to an interface for joining a social media platform or group about the movie, movie characters, issues addressed in the movie, communities interested in the movie, or even social media platforms/groups/communities unrelated (or only partially related) to the movie. Some of these social media communities may be referred to as “semantically interlinked online communities,” or SIOC for short.

A SIOC may be designed/configured to focus on the feature movie itself, or on a scene, character, theme, or issue in the feature movie. Presenting to a moviegoer an opportunity to engage in a SIOC and similar or analogous interfaces/communities/associations immediately after a movie has ended—e.g., through a QR code link presented during closing credits—is beneficial because the movie is fresh in the moviegoer's mind and the moviegoer may therefore be more interested and able to respond and engage. Engagement may comprise, e.g., responding to a question/prompt such as “What is your favorite scene?” or “In what way did the movie move you?”

An additional benefit of engaging moviegoers during movie credits (or at other times) through a QR code or link in the theater is the phenomenon of social momentum: moviegoers who observer other moviegoers pulling out their phones, following the QR code, and/or otherwise engaging with the special message and/or associated QR code—are more likely to do the same themselves. This may be referred to as “social momentum.”

### IV. Trailer Valuation Based on Presales

In a typical sale of a trailer spot to a third party—e.g., sale of a trailer spot for a feature movie to a movie distributor who wishes to show a trailer for its movie in conjunction with a showing the feature film at a particular movie showing or set of movie showings—the sale price is based on speculation/estimation by both the party selling the trailer spot and the party purchasing the trailer spot as to the actual number of moviegoers who will see the trailer spot, as well as the characteristics/demographics/preferences of such moviegoers who will actually see the trailer.

But if the actual number of moviegoers (and possibly their characteristics/demographics/preferences) who will be attending a particular movie showing are known, the distributor of the feature movie, the distributor of the trailer movie, or both can more accurately value the trailer spot. The more information that is known about the audience that will see a trailer spot, the more accurately the trailer spot may be valued.

### General

As with other ticket-related innovations described herein, although the disclosure focuses on ticket sales for movies, the disclosed innovations and inventions may be analogously applied to other events requiring or using tickets, in-person attendance, etc.

The systems and methods described herein may comprise using a server, laptop, smartphone, tablet, or other computing device to execute computer-readable instructions stored on non-transitory media.

Although the disclosure herein refers in some instances to decisions or determinations being made by an Experience Optimization Server, some decisions or determinations may be made by a human independent of the Experience Optimization Server or in conjunction with the Experience Optimization Server. For example, the Experience Optimization Server may provide to a human user a set of options, e.g., a list of options, a ranked list of options, and/or a list of options with ratings or features of such options.

What is claimed is:

1. A method, comprising:
obtaining audience characteristics information for an event; and
customizing the event based on the audience characteristics information.

2. The method of claim 1, wherein audience characteristics information comprises at least one from the following list:
for at least one member of the audience, media content preferences associated with the member;
for at least one member of the audience, media consumption history associated with the member; and
for at least one member of the audience, demographics information associated with the member.

3. The method of claim 1, wherein obtaining audience characteristics information for an event comprises at least one from the following list:
obtaining information that a member of the audience provided to an electronic device or electronic system;
obtaining information that a friend or associate of a member of the audience provided to an electronic device or electronic system;
obtaining information from a third party about online behavior of a member of the audience;
obtaining information from a third party about a member of the audience;
obtaining information from demand shaping for ticket sales and/or marketing for the event; and
obtaining demand identification information from tickets sold for the event, tickets sold for a related event, and/or marketing response to marketing for the event.

4. The method of claim 3, wherein demand shaping for ticket sales and/or marketing for the event comprises at least one from the following list:
directed marketing for the event; and
marketing characteristics for the event.

5. The method of claim 4, wherein directed marketing comprises at least one from the following list:
marketing on a specific medium;
marketing at a specific physical location;
marketing at a specific virtual location;
marketing that targets individuals having one or more specific features;
marketing that targets classes of individuals having one or more specific features; and
multiple ticket bundling.

6. The method of claim 3, wherein demand identification information comprises information based on at least one from the following list:
characteristics of at least one ticket purchaser for the event;
circumstances of at least one ticket purchase for the event; and
information about purchases of multiple tickets.

7. The method of claim 6, wherein circumstances of at least one ticket purchase for the event comprises information about at least one from the following list:
a specific online platform associated with the at least one ticket purchase for the event; and
a specific advertisement associated with the at least one ticket purchase for the event.

8. The method of claim 1, wherein:
the event is a movie showing in a theater; and
customizing the event based on the audience characteristics information comprises at least one from the following list:
customizing a trailer presented in conjunction with the movie showing;
customizing marketing presented in conjunction with the movie showing;
customizing concessions;
customizing merchandise; and
customizing content in the movie showing.

9. The method of claim 8, wherein customizing content in the movie showing may comprise product placement.

10. The method of claim 1, wherein customizing content in the movie showing may comprise removal of objectionable content.

11. A method for customizing a movie showing, comprising:
obtaining audience characteristics information for an event, comprising at least one from the following list:
obtaining information from demand shaping for ticket sales and/or marketing for the event;
obtaining demand identification information from tickets sold for the event, tickets sold for a related event, marketing reaction to marketing for the event; and
customizing the event based on the audience characteristics information.

12. The method of claim 11, wherein demand shaping for ticket sales and/or marketing for the event comprises at least one from the following list:
directed marketing for the event; and
marketing characteristics for the event.

13. The method of claim 11, wherein demand identification information comprises information based on at least one from the following list:
characteristics of at least one ticket purchaser for the event;
circumstances of at least one ticket purchase for the event; and
information about purchases of multiple tickets.

14. The method of claim 11, wherein customizing the event based on the audience characteristics information comprises at least one from the following list:
customizing a trailer presented in conjunction with the movie showing;
customizing marketing presented in conjunction with the movie showing;
customizing concessions;
customizing merchandise; and
customizing content in the movie showing.

15. A system, comprising:
an experience optimization server;
non-transitory computer-readable instructions that when executed cause a processor associated with the experience optimization server to:
obtain audience characteristics information for a movie showing, comprising at least one from the following list:
obtain information from demand shaping for ticket sales and/or marketing for the event; and
obtain demand identification information from tickets sold for the event, tickets sold for a related event, marketing reaction to marketing for the event; and
customize the event based on the audience characteristics information.

16. The system of claim 15, wherein customizing the event based on the audience characteristics information comprises recommending to or automatically customizing a trailer associated with the movie showing.

17. The system of claim 16, wherein recommending to or automatically customizing a trailer associated with the movie showing comprises automatically customizing a trailer associated with the movie showing.

18. The system of claim 15, wherein customizing the event based on the audience characteristics information comprises recommending to or automatically customizing content in the movie showing.

19. The system of claim 18, wherein recommending to or automatically customizing content in the movie showing comprises automatically customizing content in the movie showing.
